(19) United States
(12) Patent Application Publication
(10) Pub. No.: US 2015/0077340 A1
(43) Pub. Date: Mar. 19, 2015

(54) METHOD, SYSTEM AND COMPUTER PROGRAM PRODUCT FOR REAL-TIME TOUCHLESS INTERACTION

(71) Applicant: Genius Toy Taiwan Co., Ltd., Taichung (TW)

(72) Inventor: Wen-Pin LIN, TAICHUNG (TW)

(73) Assignee: Genius Toy Taiwan Co., Ltd., Taichung (TW)

(21) Appl. No.: 14/029,993

(22) Filed: Sep. 18, 2013

(51) Int. Cl. G06F 3/0346

(52) U.S. Cl. CPC G06F 3/0346
USPC 345/158

(57) ABSTRACT

The real-time touchless interaction method of the present invention comprises the following steps: characteristic information of an object is acquired; the characteristic information is recognized and used to generate a 3D icon which corresponds to the object; the characteristic information of the object continues to be acquired, and the 3D icon is reconstructed in real-time based on how the object is manipulated; at the same time, the 3D icon is utilized as an pointer to interact with the smart device without requiring any physical manipulation with the touch screen. A system and a computer program product for real-time touchless interaction are disclosed herein. The present invention enables users to interact with a smart device without physically touching the screen, thereby generating a plethora of new interactive applications and greatly increasing the versatility of available operations between the user and the smart device.

### BACKGROUND OF THE INVENTION

1. Field of the Invention

The present invention relates to an interaction technology, particularly to a method, system and computer program product for real-time touchless interaction.

2. Description of the Related Art

People want to be able to search, receive, and share information anytime they please, which is why mobile devices equipped with internet access—especially easy-to-carry smart phones and tablet computers with touch screens—are so popular. In fact, these products have become practically integral to leading a modern lifestyle. Users are spending an increasing amount of time using smart devices to browse the web, read, play games, take photographs, and chat with friends. A touch screen is the main interface for communicating using these types of smart devices. Touch screens consist of touch sensor panels that enable users to perform various functions by tapping or dragging their fingers (or other object such as a stylus) on or over the on-screen user interface (UI) display. Hence, in addition to using speech recognition technology to make phone calls, users can perform a variety of commands on a smart device by physically touching the screen. However, these technologies still have some limitations, which is why manufacturers are continually striving to develop improved human-machine interfaces and systems using innovative methods.

### SUMMARY OF THE INVENTION

One objective of the present invention is to provide a method, system, and computer program product for real-time touchless interaction. The present invention creates a new interactive system for smart devices which enable users to more effectively interact with their device without having to physically touch a screen. This in turn opens up a variety of new possibilities for increased interactivity, making smart devices more versatile, easier to use, and more efficient for users to operate.

Another objective of the present invention is to provide a real-time touchless interaction method which is applicable to a smart device. The method comprises the following steps. A characteristic information of an object is acquired. The characteristic information is recognized to generate a 3D icon corresponding to the object. The characteristic information of the object is successively acquired, and used to reconstruct the 3D icon in real time based on how the object is manipulated, wherein the 3D icon is utilized to act as a pointer to interact with said smart device without physically touching the smart device.

Yet another objective of the present invention is to provide a real-time touchless interaction system. The system comprises an object which is provided with a characteristic information and a smart device, wherein the smart device further comprises a capture module to acquire the characteristic information; a recognition module electrically connected with the capture module to recognize the characteristic information; and an image generation module electrically connected with the capture module and the recognition module to generate a 3D icon which corresponds to the object on a display screen of the smart device. The capture module is utilized to successively capturing an image from the object to rebuild said 3D icon in real time according to the manipulation of the object, wherein the 3D icon is utilized to act as a pointer to interact with the smart device without physically touching the smart device.

A further objective of the present invention is to provide a computer program product which is loaded into a smart device to perform a real-time touchless interaction method as described.

Below, the embodiments will be described in detail in cooperation with the attached drawings to make easily understood the objectives, technical contents, characteristics and accomplishments of the present invention.

### BRIEF DESCRIPTION OF THE DRAWINGS

FIG. 1 is a flowchart of a touchless interaction method according to one embodiment of the present invention;

FIG. 2 is a block diagram schematically a touchless interaction system according to one embodiment of the present invention;

FIG. 3A and FIG. 3B are diagrams schematically a touchless interaction system according to a first embodiment of the present invention;

FIG. 4A-1, FIG. 4A-2, FIG. 4B, FIG. 4C-1, FIG. 4C-2, FIG. 4C-3, FIG. 4D-1, FIG. 4D-2, FIG. 4D-3, FIGS. 4D-4, 4D-5, and 4D-6 are diagrams schematically showing objects according to embodiments of the present invention;

FIG. 5A-1, FIG. 5A-2, FIG. 5B-1 and FIG. 5B-2 are diagrams schematically a touchless interaction system according to a second embodiment of the present invention;

FIG. 6A, FIG. 6B and FIG. 6C are diagrams schematically a touchless interaction system according to a third embodiment of the present invention; and

FIG. 7A-1, FIG. 7A-2 and FIG. 7B are diagrams schematically a touchless interaction system according to a fourth embodiment of the present invention.

### DETAILED DESCRIPTION OF THE INVENTION

The present invention provides a method, system, and computer program product for real-time touchless interaction. The real-time touchless interaction system of the present invention comprises an object and a smart device, wherein the object is provided with a characteristic information. The system can enable users to manipulate the object to interact with the smart device without physically touching the screen. Below, some embodiments will be described in detail in cooperation with drawings to exemplify the present invention. In addition to the embodiments described, the present invention also widely applies to various embodiments. Any equivalent substitution, modification, or variation according to the spirit of the present invention is to be also included within the scope of the present invention, which is based on the claims stated below. In order to enable the readers to comprehend the present invention more fully, many specified details are described in the specification. However, the present invention can still work while the specified details are partially or totally omitted. Besides, the steps or elements that have been universally known to the persons skilled in the art are not described in the specification lest the present invention be unnecessarily limited by them. In the attached drawings, identical/similar elements would be represented by identical/similar symbols. The attached drawings do not exactly express the actual dimensions or magnitudes of the present invention but only schematically represent the present invention. Further, all unconcerned details do not appear in the attached drawings lest key points be out of focus.

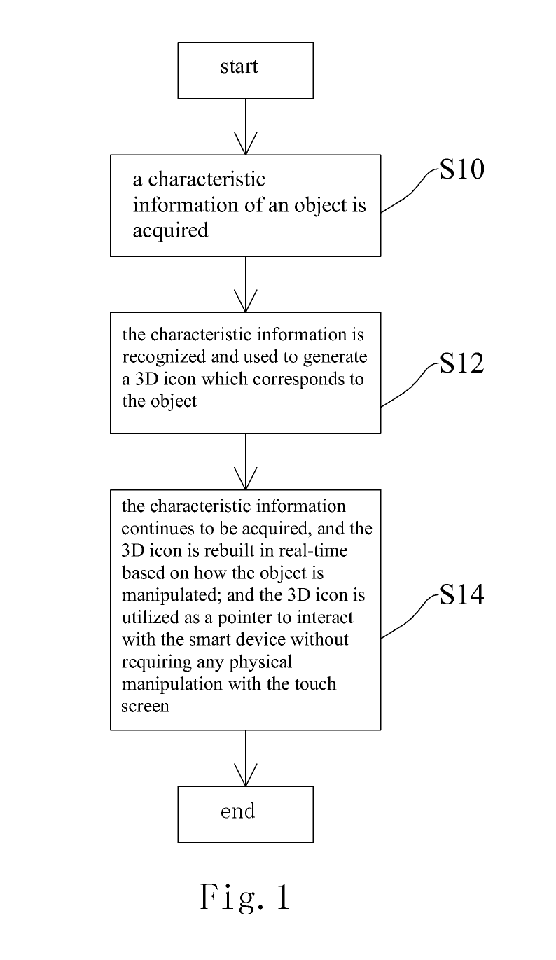

FIG. 1 is a flowchart that illustrates how real-time touchless interaction works using one embodiment of the present invention. This embodiment for real-time touchless interaction provided by the present invention is applicable to a smart device. Applications include, but are not limited to, smart phones, tablet computers, notebook computers, personal digital assistants, and smart televisions. The real-time touchless interaction method of the present invention comprises the following steps. A characteristic information of an object is acquired (Step S10). The characteristic information is recognized and used to generate a 3D icon which corresponds to the object (Step S12). The characteristic information of the object continues to be acquired, and the 3D icon is reconstructed in real-time based on how the object is manipulated; at the same time, the 3D icon is utilized as a pointer to interact with the smart device without requiring any physical manipulation with the touch screen (Step S14).

In Step S10, the characteristic information may be a configuration of information, which is a combination of at least one characteristic of the object, wherein the characteristic may be a color, shape, or size of the object. In another embodiment, the characteristic information could comprise a configuration information, an electronic tag information, a patterned tag information, or the combination thereof. In the case of characteristic information being configuration information or patterned tag information, the method for acquiring the characteristic information includes capturing an image of the object and acquiring the characteristic information according to at least one characteristic of the object. In Step S12, after the characteristic information is acquired, the characteristic information is analyzed and recognized to generate a 3D icon corresponding to the object according to the result of analysis and recognition, wherein the 3D icon is utilized to function as a pointer on the screen of the smart device. In one embodiment, the 3D icon is a 3D image generated via interpreting the configuration information or the patterned tag information; and in another embodiment, the 3D icon is a 3D mirror image which corresponds to the object. Furthermore, in the smart device, at least a portion of the graphic information of the 3D icon can be stored in advance. After the characteristic information is recognized, the corresponding 3D icon is then retrieved from the graphic information based on the recognition result, wherein the graphic information stored in the smart device is updatable. In another embodiment, when the characteristic information is electronic tag information, the electronic tag can be attached to the surface of the object or arranged inside the object, and then this electronic tag information can be acquired via a wireless communication technology.

In Step S14, the characteristic information is successively acquired from the object to rebuild the 3D icon according to the manipulation of the object in real time. The method for reconstructing the 3D icon includes the following steps: the successively acquired characteristic information is utilized to estimate a tilt angle of the object; the tilt angle is then utilized to reconstruct the 3D visualization of the 3D icon. In addition, the method for reconstructing the 3D icon can include the following steps: the successively acquired characteristic information utilized to estimate the displacement information of the object; and the displacement information utilized to estimate the position of the 3D icon. The displacement information includes the displacement magnitude and displacement direction of the object. The reconstruction of the 3D icon can be used to reflect how the object is manipulated. The user can manipulate the object to execute a touchless interaction with the smart device. Herein, “interaction” means: the smart device acquires relevant information while the object is moved, e.g., dragged or rotated, and responds to this information. The present invention uses the generated 3D icon as a substitute for having to physically contact the touch screen using a stylus or finger; therefore, the present invention can enable the user to carry out “touchless interactive tasks” with the smart device.

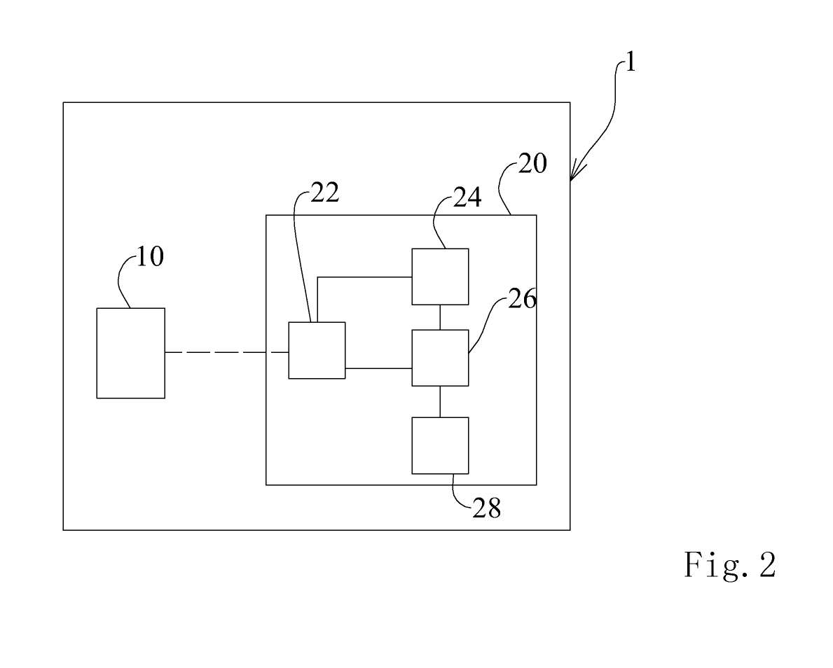

FIG. 2 is a block diagram representing a touchless interaction system according to one embodiment of the present invention. The real-time touchless interaction system 1 of the present invention comprises an “object 10” and a “smart device 20”. The object 10 is provided with a characteristic information. The smart device 20 includes a capture module 22, a recognition module 24 and an image generation module 26. In the system, the capture module 22 is utilized to acquire the characteristic information of object 10. The recognition module 24 is electrically connected to the capture module 22 and utilized to recognize the characteristic information acquired by the capture module 22. The image generation module 26 is electrically connected with capture module 22 and recognition module 24 and utilized to generate a 3D icon which corresponds to object 10 on the display screen of smart device 20, wherein the 3D icon acts as a pointer on the display screen. In addition, the capture module 22 is utilized to successively acquire the characteristic information of the object 10; thereafter, the recognition module 24 can use the successively-acquired characteristic information to rebuild the 3D icon in real time, enabling the user to manipulate the object to interact with the smart device 20 without physically touching the screen. The abovementioned characteristic information may comprise the configuration information, i.e., a permutation or combination of at least one characteristic of the object 10, wherein the characteristic may be a color, shape, or size of the object 10. In other embodiments, the characteristic information may comprise the electronic tag information or the patterned tag information. Moreover, the abovementioned smart device 20 abovementioned could be, but is not limited to, a smart phone, tablet computer, notebook computer, personal digital assistant, or smart television. In one embodiment, smart device 20 includes a storage module 28 to store a portion of graphic information of the 3D icons for which the graphic information is updatable. For instance, the smart device 20 can receive external information to update the graphic information and redefine the characteristics of the object 10.

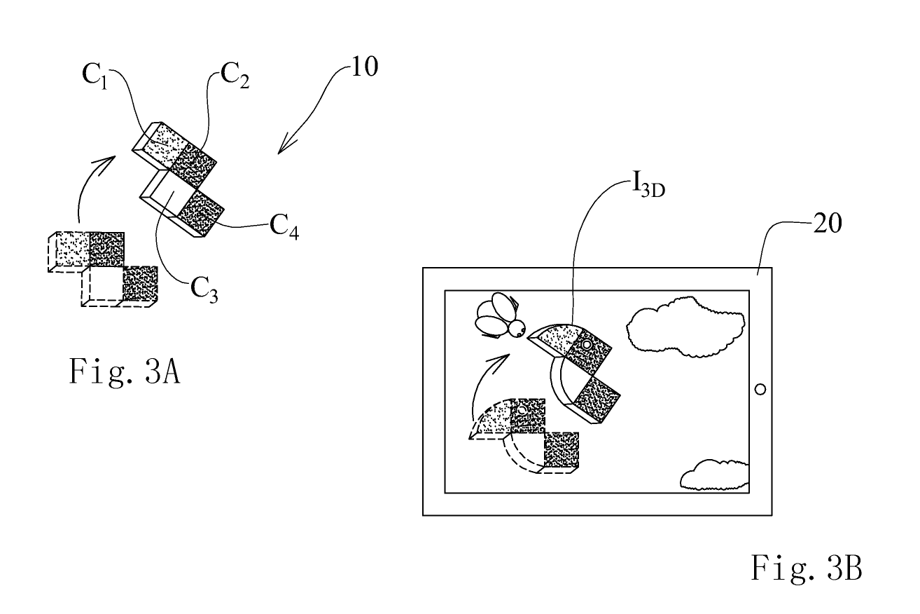

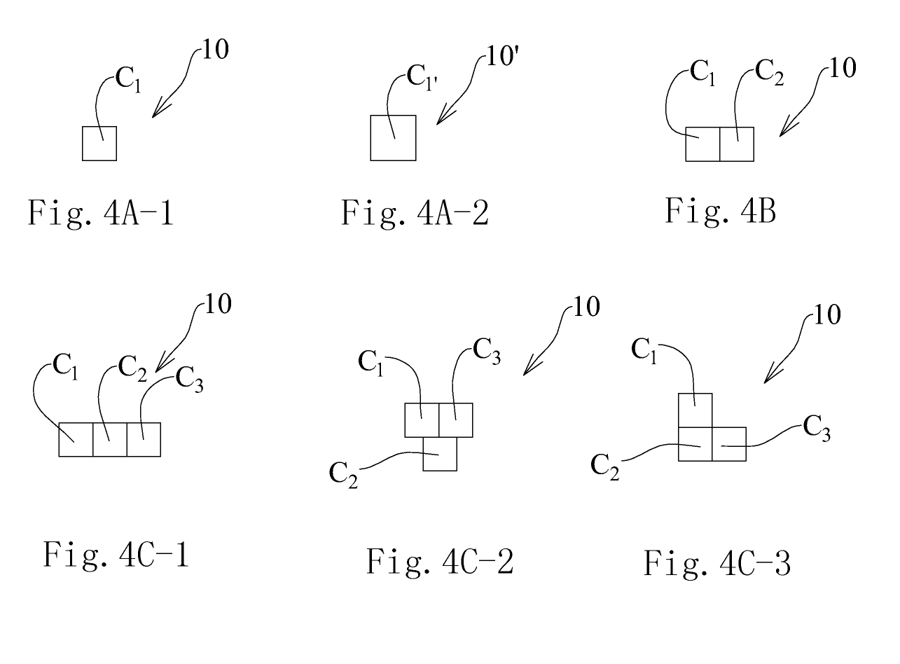

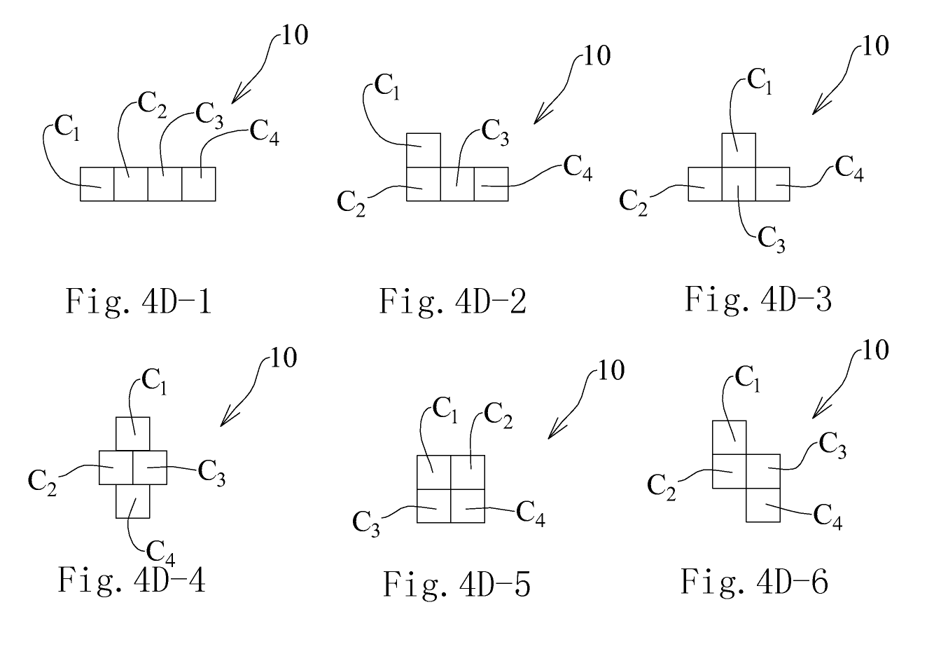

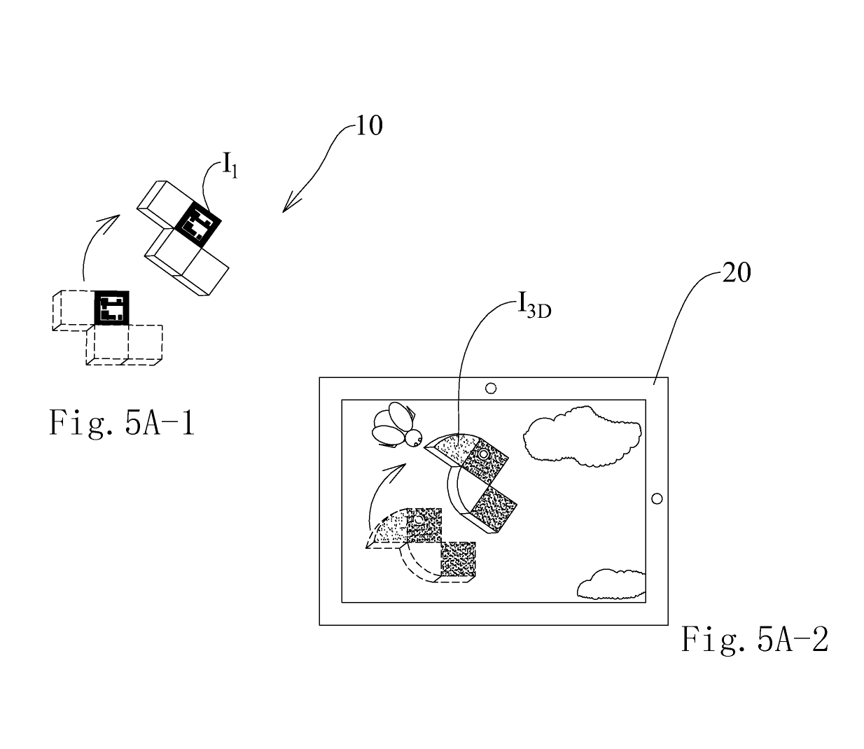

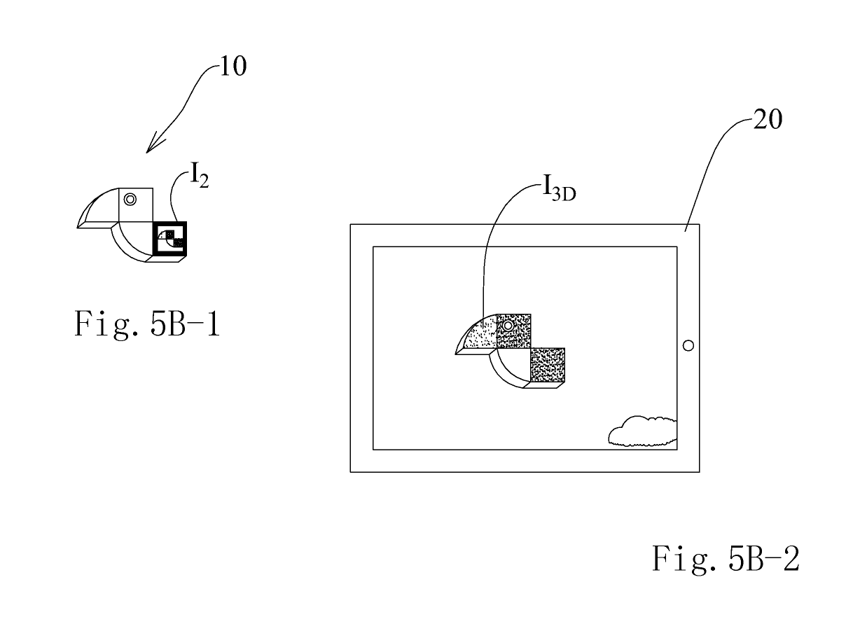

FIG. 3A and FIG. 3B illustrate a real-time touchless interaction system according to a first embodiment of the present invention. The real-time touchless interaction system comprises an “object 10” and a “smart device 20”. The characteristic information of the object 10 is exemplified by the configuration information provided in FIG. 3A. Before describing the first embodiment, the meaning of configuration information is explained in FIG. 4A-1 to FIG. 4D-6 beforehand so that persons skilled in the art can grasp the meaning of configuration information. A group of cuboid blocks are used to exemplify the object 10 in FIG. 4A-1 to FIG. 4D-6. However, the present invention is not limited by these figures. Based on the variation of the permutation or combination of at least one characteristic of the object 10, the smart device 20 is capable of interpreting the object 10 into different articles. The characteristic of the object 10 may comprise a color, shape, or size of the object 10, or a combination thereof. Refer to FIG. 4A-1. In this configuration, for example, suppose that a single block represents a “small ball” and that Color C₁ of the block is red. Here, the smart device 20 can interpret the object 10 as “a small red ball”. Refer to FIG. 4A-2, wherein the object 10′ also represents a ball. As shown in these figures, the object 10′ can be used to represent a “big ball” because the object 10′ is larger than the object 10. In this case, the smart device 20 can interpret the object 10′ as “a big blue ball” if Color Cr of the object 10′ is defined to blue. In another design, the red object 10 can be interpreted to a “ball”, and the blue object 10′ can be interpreted to a “house”. FIG. 4B, FIG. 4C-1, FIG. 4C-2, FIG. 4C-3, FIG. 4D-1, FIG. 4D-2, FIG. 4D-3, FIG. 4D-4, FIG. 4D-5, and FIG. 4D-6 illustrate an example structure of the object based on various embodiments. According to this same principle, different colors, shapes, sizes, or different combinations thereof can represent different articles respectively; the details thereof will not be repeated here. Colors C₁, C₂, C₃, and C₄ may represent an identical color or different colors respectively. In addition, the object 10 is not limited to taking the form of a cuboid block or group of cuboid blocks.

In the first embodiment shown in FIG. 3A, the object 10 is made up of four blocks having Colors C₁, C₂, C₃, and C₄, respectively, which are separately defined as light gray, dark gray, white, and dark gray. When operating the system in accordance with the present disclosure, the capture module 22 of smart device 20 can capture an image containing the object 10 and obtain the characteristic information of the object 10 from the abovementioned combination of the characteristics of the object 10. The recognition module 24 (shown in FIG. 2) can recognize the characteristic information received by capture module 22 and interpret the object 10 using preset definitions as a bird with a dark gray body, a light gray beak, and a white belly. Based on the interpretation, the image generation module 26 (shown in FIG. 2) can subsequently generate a 3D icon I_{3D} (a bird with a dark gray body, a light gray beak, and a white belly) that corresponds to the object 10 on the screen of the smart device 20 (shown in FIG. 3B) to function as a pointer on the screen. During the operation, the capture module 22 must successively acquire the characteristic information of the object 10, and then the recognition module 24 can use the successively-acquired characteristic information to rebuild the 3D icon I_{3D} in real time. Hence, the user can manipulate the 3D icon I_{3D} on the screen by manipulating the object 10 or by moving the smart device 20 to interact with a specified application installed on the smart device 20. For example, when the user directly moves the object 10, the capture module 22 successively acquires the images containing the configuration information of the object 10; this enables the recognition module 24 to estimate the displacement and/or tilt angle from the configuration information of object 10. Then, the recognition module 24 can estimate the relative movement of object 10 to reconstruct a 3D visualization of the 3D icon which accords to the tilt angle and/or magnitude and direction of the displacement. In one embodiment, the relative movement is generated via moving the smart device 20. In different scenarios, the user may move the object 10 to manipulate the 3D icon on the screen to make a selection so as to change the appearance of the 3D icon. More specifically, the object 10 was originally represented as a bird with a dark gray body, light gray beak, and white belly; but by selecting another option shown on the screen, the object 10 can be re-programmed to represent a puppy, another animal, or even a plant. Therefore, in the present invention, manipulation of the object is utilized to replace physical contact on the touch screen with a stylus or finger, thereby enabling the user to execute touchless interaction with the smart device.

Schematic diagrams of the touchless interaction system based on a second embodiment of the present invention are as illustrated FIG. 5A-1, FIG. 5A-2, FIG. 5B-1, and FIG. 5B-2. The second embodiment differs from the first embodiment in that the characteristic information of the object 10 is exemplified by patterned tag information. The patterned tag may comprise barcodes, graphs, geometric shapes, text, or a combination thereof, wherein the patterned tag information is defined as the information contained in the patterned tag. The barcode may be a one-dimensional barcode or a two-dimensional barcode. In one exemplary embodiment, as shown in FIG. 5A-1, a two-dimensional barcode is contained in the patterned tag I₁; and in one another exemplary embodiment a graph is contained in the patterned tag I₂ shown in FIG. 5B-1. In the second embodiment, the object 10 is made up of four blocks. The blocks may be cuboids (shown in FIG. 5A-1) or geometric shapes (shown in FIG. 5B-1). The patterned tags are attached to at least one surface of the blocks. The abovementioned patterned tags can be used jointly. In the second embodiment, the capture module successively acquires the characteristic information of the object 10, and the recognition module uses the characteristic information successively acquired by the capture module to reconstruct the 3D icon I_{3D} in real time. The user may manipulate the 3D icon I_{3D} on the screen via manipulating the object 10 or by moving the smart device 20 to interact with a specified application installed on the smart device 20, all without having to physically touch the device's screen. Possible interactive applications between the user and smart device could include an interactive educational application or interactive touch-free game, among other potential applications.

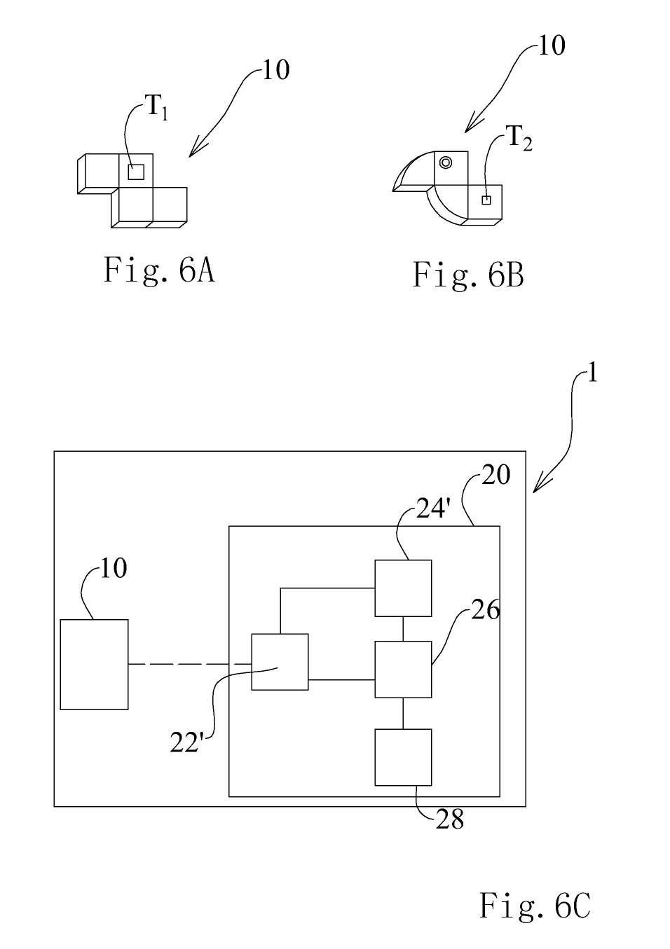

The schematics for the touchless interaction system used in a third embodiment of the present invention are as illustrated in FIG. 6A, FIG. 6B and FIG. 6C. The third embodiment differs from the abovementioned embodiments in that the characteristic information of object 10 is exemplified by electronic tag information. In the third embodiment, the object 10 is also made up of four blocks. The blocks may be cuboids (shown in FIG. 6A) or geometric shapes (shown in FIG. 6B). The electronic tag may be arranged inside object 10 (such as the electronic tag T₁ shown in FIG. 6A) or attached to one surface of the blocks (such as the electronic tag T₂ shown in FIG. 6B). In the third embodiment, the capture module 22′ is a wireless-signal receiving module, and the recognition module 24′ is a wireless-signal recognition module, wherein the wireless-signal receiving module successively acquires the characteristic information of the object 10, and the wireless-signal recognition module uses the characteristic information to reconstruct the 3D icon in real time. The other actions of the system are identical to those of the abovementioned embodiments, and will not be repeated here. In one embodiment using a different design, the wireless-signal receiving module and the wireless-signal recognition module can also be integrated into one module.

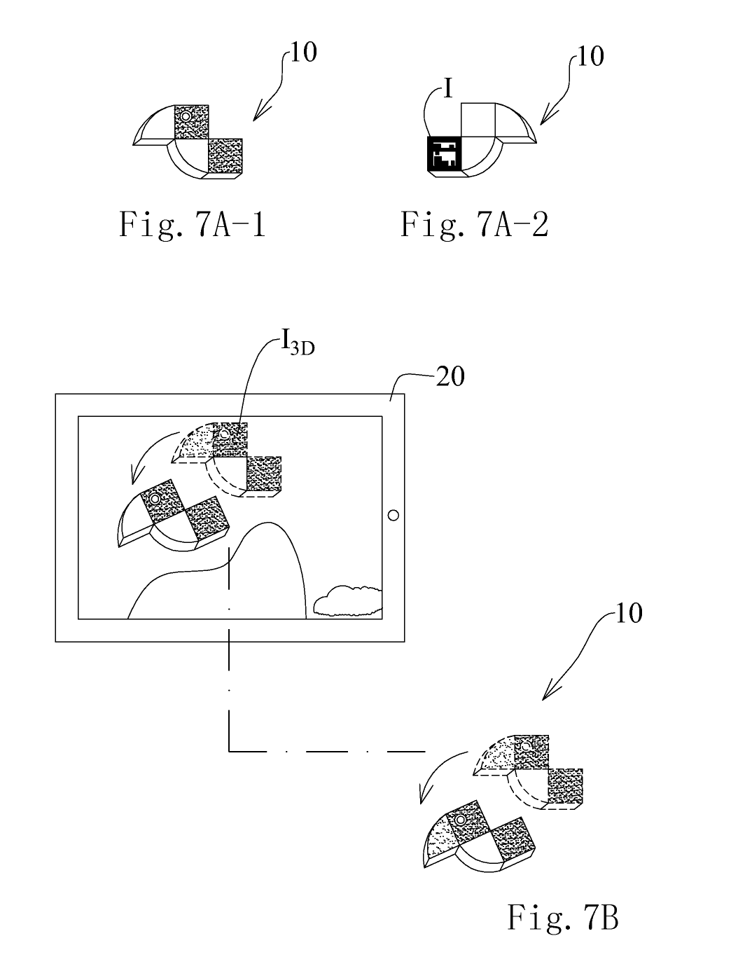

In the abovementioned embodiments, the object appears behind the smart device. Therefore, the smart device uses a rear camera to capture images of the object. A fourth embodiment of the present invention, illustrated in FIG. 7A-1, FIG. 7A-2, and FIG. 7B, is described herein. The fourth embodiment differs from the abovementioned embodiments in that the object 10 appears in front of the smart device 20 and the smart device 20 uses a front camera to capture images of the object 10. In the fourth embodiment, the characteristic information of the object 10 is exemplified by the patterned tag information. The patterned tag I is attached to the rear end of object 10 (as shown in FIG. 7A-2). Similar to the abovementioned embodiment, the patterned tag I may contain barcodes or other patterns. In this embodiment, the patterned tag I faces the front camera of the smart device 20. When operating the system, the capture module of the smart device 20 can acquire the patterned tag information of the object 10, and then the recognition module can recognize the patterned tag information to generate a 3D mirror image on the screen of the smart device that corresponds to the object; this enables the user to manipulate the object 10 such that it interacts with an application on smart device 20 without physically touching the screen. In one embodiment, the application could be a game or an educational program. The user can execute various tasks and/or make selections by moving the object to manipulate the corresponding 3D mirror image on the screen.

In addition, the present invention discloses a computer program product which is loaded into a smart device to initiate the touchless interaction capability. For example, the computer program product may be applications(Apps) which is loaded into a smart device to perform a real-time touchless interaction method as described. The details of the method have already been described above and will not be repeated here.

Although various embodiments have been described with reference to the accompanying drawings, it is to be noted that various changes and modifications will become apparent to those skilled in the art.

In summary, the present invention is characterized by enabling a smart device to successively acquire variations of characteristic information of an object so as to enable the user to manipulate a corresponding 3D icon generated by the smart device. The 3D icon can be thought of as a virtual operating object which is generated to correspond with a physical object. The characteristic information could comprise a configuration information containing the color, shape, or size of the object, or a combination thereof. Moreover, the characteristic information can comprise an electronic tag information or a patterned tag information. The object may be made up of a plurality of sub-objects using identical or separate colors, shapes, and/or sizes. The permutations or combinations of the sub-objects may be used to define a plurality of operating objects. Therefore, the present invention offers designers considerable flexibility. The present invention also enables the user to manipulate the operating object and interact with the smart device using relative movements rather than physically touching the screen of the smart device using a finger or stylus. This opens up a variety of interesting new possibilities vis-à-vis how a user can operate a smart device.

In conclusion, the present invention proposes a method, system and computer program product for touchless interaction. The present invention creates a new interactive system and method for smart devices which enable users to more effectively interact with their device without having to physically touch a screen. Further, a new experience is created to smoothly combine the physical operating experiences and virtual simulation technology. This in turn opens up a variety of new possibilities for increased interactivity, making smart devices more versatile, easier to use, and more efficient for users to operate.

The embodiments described above are to demonstrate the technical thought and characteristics of the present invention so as to enable the persons skilled in the art to understand, make, and use the present invention. However, these embodiments are not intended to limit the scope of the present invention. Any equivalent modification or variation according to the spirit of the present invention is to be also included within the scope of the present invention.

What is claimed is:

1. A method of real-time touchless interaction, which is applicable to a smart device, said method comprising:
acquiring a characteristic information of an object;
recognizing said characteristic information to generate a 3D icon corresponding to said object; and
successively acquiring said characteristic information of said object, and reconstructing said 3D icon in real time according to the manipulation of said object, wherein said 3D icon is utilized to act as an pointer to interact with said smart device without physically touching said smart device.

2. The method according to claim 1, wherein the method for acquiring said characteristic information includes: capturing an image of said object and acquiring said characteristic information according to at least one characteristic of said object.

3. The method according to claim 1, wherein said characteristic information comprises a configuration information, an electronic tag information, a patterned tag information, or the combination thereof, and wherein said configuration information is a combination of at least one characteristic of said object, wherein said characteristic may be the color, the shape, or the size of said object.

4. The method according to claim 1, wherein said characteristic information comprises said electronic tag information, the method for acquiring said characteristic information comprises a step: using a wireless communication technology to communicate with said object to acquire said characteristic information from said object.

5. The method according to claim 1, wherein said 3D icon is a 3D image generated via interpreting said configuration information.

6. The method according to claim 1, wherein said 3D icon is a 3D mirror image which corresponds to said object.

7. The method according to claim 1, wherein at least a portion of graphic information of said 3D icons is stored in said smart device, and wherein after said characteristic information is recognized, said corresponding 3D icon is then retrieved from said graphic information based on a recognition result, and said graphic information is updatable.

8. The method according to claim 1, wherein the method for reconstructing said 3D icon comprises steps: estimating a tilt angle of said object from said characteristic information which is successively acquired from said object; and rebuilding the 3D visualization of said 3D icon according to said tilt angle.

9. The method according to claim 1, wherein the method for reconstructing said 3D icon includes steps: estimating the displacement information of said object from said characteristic information which is successively acquired from said object; and estimating a position of said 3D icon from said displacement information.

10. The method according to claim 9, wherein said displacement information comprises the displacement magnitude and the displacement direction of said object.

11. A real-time touchless interactive system comprising an object having a characteristic information; and
a smart device, comprising:
a capture module to acquire said characteristic information of said object;
a recognition module electrically connected with said capture module to recognize said characteristic information; and
an image generation module electrically connected with said capture module and said recognition module to generate a 3D icon which corresponds to said object on the display screen of said smart device, wherein
said capture module successively capturing said characteristic information from said object to rebuild said 3D icon in real time according to the manipulation of said object, wherein said 3D icon is utilized to act as a pointer to interact with said smart device without physically touching the display screen of said smart device.

12. The real-time touchless interactive system according to claim 11, wherein said characteristic information comprises a configuration information, an electronic tag information, a patterned tag information, or the combination thereof, and wherein said configuration information is a combination of at least one characteristic of said object, wherein said characteristic may be the color, the shape, or the size of said object.

13. The real-time touchless interactive system according to claim 12, wherein said characteristic information includes said electronic tag information, and wherein said capture module includes a wireless-signal receiving module to wirelessly communicate with said object, and said recognition module includes a wireless-signal recognition module to recognize said characteristic information retrieved from said object.

14. The real-time touchless interactive system according to claim 11, wherein said capture module is an image capture module utilized to capture an image of said object; and said recognition module is an image recognition module utilized to recognize said characteristic information retrieved from said object.

15. The real-time touchless interactive system according to claim 11, wherein said smart device comprises a smart phone, a tablet computer, notebook computer, a personal digital assistant or a smart television.

16. The real-time touchless interactive system according to claim 11, wherein said smart device comprises a storage module to store at least a portion of graphic information of said 3D icons.

17. The real-time touchless interactive system according to claim 16, wherein said graphic information is updatable.

18. The real-time touchless interactive system according to claim 11, wherein said recognition module is utilized to estimate a tilt angle of said object from said characteristic information which is successively acquired by said capture module; and said recognition module is utilized to rebuild the 3D visualization of said 3D icon according to said tilt angle.

19. The real-time touchless interactive system according to claim 11, wherein said recognition module is utilized to estimate the displacement information of said object from said characteristic information which is successively acquired by said capture module and said recognition module is utilized to estimate a position of said 3D icon according to said displacement information.

20. The real-time touchless interactive system according to claim 19, wherein said displacement information comprises the displacement magnitude and the displacement direction of said object.

21. A computer program product, which is loaded into a smart device to execute a method of real-time touchless interaction, said method comprising:
acquiring a characteristic information of an object;
recognizing said characteristic information to generate a 3D icon corresponding to said object; and
successively acquiring said characteristic information of said object, and reconstructing said 3D icon in real time according to the manipulation of said object, wherein said 3D icon is utilized to act as an pointer to interact with said smart device without physically touching said smart device.

22. The computer program product according to claim 21, wherein the method for acquiring said characteristic information includes:
capturing an image of said object and acquiring said characteristic information according to at least one characteristic of said object.

23. The computer program product according to claim 21, wherein said characteristic information comprises a configuration information, an electronic tag information, a patterned tag information, or the combination thereof, and wherein said configuration information is a combination of at least one characteristic of said object, wherein said characteristic may be the color, the shape, or the size of said object.

24. The computer program product according to claim 21, wherein said characteristic information comprises said electronic tag information, the method for acquiring said characteristic information comprises a step: using a wireless communication technology to communicate with said object to acquire said characteristic information from said object.

25. The computer program product according to claim 21, wherein said 3D icon is a 3D image generated via interpreting said configuration information.

26. The computer program product according to claim 21, wherein said 3D icon is a 3D mirror image which corresponds to said object.

27. The computer program product according to claim 21, wherein at least a portion of graphic information of said 3D icons is stored in said smart device, and wherein after said characteristic information is recognized, said corresponding 3D icon is then retrieved from said graphic information based on a recognition result, and said graphic information is updatable.

28. The computer program product according to claim 21, wherein the method for reconstructing said 3D icon comprises steps: estimating a tilt angle of said object from said characteristic information which is successively acquired from said object; and rebuilding the 3D visualization of said 3D icon according to said tilt angle.

29. The computer program product according to claim 21, wherein the method for reconstructing said 3D icon includes steps: estimating the displacement information of said object from said characteristic information which is successively acquired from said object; and estimating a position of said 3D icon from said displacement information.

30. The computer program product according to claim 29, wherein said displacement information comprises the displacement magnitude and the displacement direction of said object.
